(19) United States
(12) Patent Application Publication
(10) Pub. No.: US 2025/0319454 A1
(43) Pub. Date: Oct. 16, 2025

(54) CATALYST SUPPORT

(71) Applicant: JEMMTEC LIMITED, Dewsbury West Yorkshire (GB)

(72) Inventors: Mark STUCKEY, Dewsbury West Yorkshire (GB); Richard CAULKIN, Dewsbury West Yorkshire (GB); Justine STUCKEY, Dewsbury West Yorkshire (GB)

(21) Appl. No.: 18/861,027

(22) PCT Filed: Apr. 28, 2023
(86) PCT No.: PCT/GB2023/051144

§ 371 Date: Oct. 28, 2024

(30) Foreign Application Priority Data
Apr. 29, 2022 (GB) 2206356.4

(51) Int. Cl. B01J 21/04; B01J 35/51; B01J 35/64

(52) U.S. Cl. CPC B01J 21/04; B01J 35/51; B01J 35/657

(57) ABSTRACT

There is described a support for a catalyst. The support is for use in a packed-bed reactor for the production of an alkylene oxide. The support comprises a ceramic material and has a pore size distribution wherein ≤2% of the pores have a size of ≤0.1 μm and/or has a specific surface area of at least 1.5 m²/g and/or has a total pore volume of ≥0.4 cm³/g. Also described is a catalyst comprising the support and a method for the production of alkylene oxide.

### FIELD

The present invention relates to a support for a catalyst and a supported catalyst. More specifically, the present invention relates to a support and a supported catalyst for use in the production of an alkylene oxide. The invention extends to a method for the production of an alkylene oxide using the catalyst.

### BACKGROUND

Ethylene oxide is an important industrial chemical, used as a disinfectant, sterilizing agent, and fumigant as well as an intermediate in the production of ethylene glycol, poly(ethylene glycols) and various amines.

Ethylene oxide is produced in large quantities worldwide by the direct catalytic oxidation of ethylene using either oxygen or air in the presence of a silver catalyst. This oxidation reaction occurs readily but will easily progress further than desired fully oxidising both the feed ethylene and product ethylene oxide to a mixture of carbon dioxide and water. Therefore, the main focus of a catalyst in this process is the selectivity, the ability to produce as much of the desirable ethylene oxide as possible with the minimum carbon dioxide and water.

Typically, the catalysts used in this process would be a supported silver catalyst with approximately 7-20% silver. The catalyst shape is generally produced via an extruded ceramic paste or dough which is then dried and calcined to a temperature sufficient to provide the strength needed.

A catalyst support having a high specific surface area can increase activity and allow higher volumes to be produced, however using the common catalyst production methods increasing the surface area is usually achieved by decreasing pore diameter and thereby losing the selectivity needed. To increase the surface area, it is common to decrease the size of the support pellets, however this will increase the pressure drop through a packed bed, which is limited by the capability of the production plant.

Therefore, there is a requirement for a further improved catalyst for use in the production of an alkylene oxide. It is therefore an object of aspects of the present invention to address one or more of the above-mentioned, or other, problems.

### SUMMARY

According to a first aspect of the invention there is provided a support for a catalyst, wherein the support comprises surface structures, wherein the support comprises a ceramic material; and wherein the support has a pore size distribution wherein ≤2% of the pores have a size of ≤0.1 μm and/or has a specific surface area of at least 1.5 m²/g and/or has a total pore volume of ≥0.4 cm³/g.

According to a further aspect of the invention there is provided a support for a catalyst, wherein the support comprises surface structures, and wherein the support comprises a ceramic material wherein the ceramic material comprises particle size fraction X and at least one of:
particle size fraction Y; and/or particle size fraction Z; and/or residues thereof;
wherein particle size fraction Y, when present, comprises ceramic particles with a D50 particle size that is ≤40% of the D50 particle size of particle size fraction X,
wherein particle size fraction Z, when present, comprises ceramic particles with a D50 particle size that is ≥300% of the D50 particle size of particle size fraction X.

According to a further aspect of the invention there is provided a support for a catalyst, wherein the support comprises surface structures, and wherein the support comprises a ceramic material wherein the ceramic material comprises particle size fraction X and at least one of:
particle size fraction Y comprising ceramic particles with a D50 particle size of up to 1 μm; and/or particle size fraction Z comprising ceramic particles with a D50 particle size of at least 15 μm; and/or residues thereof;
wherein the D50 particle size of particle size fraction Y, when present, is smaller than the D50 particle size of particle size fraction X,
wherein the D50 particle size of particle size fraction Z, when present, is larger than the D50 particle size of particle size fraction X.

The support may be a gel-cast support.

The support may have a substantially spherical and/or ellipsoidal macrostructure.

The support may have a pore size distribution wherein ≤2% of the pores have a size of ≤0.1 μm, such as ≤1.5%, ≤1%, ≤0.75%, or ≤0.5%. The support advantageously has improved crush strength and as a catalyst provides improved selectivity. The support may have a pore size distribution wherein ≤25% of the pores have a size of ≥10 μm, such as ≤20%, ≤15%, ≤10%, or ≤5%. The support advantageously has increased catalyst distribution throughout the support, improved selectivity, and increased catalyst lifetime.

The support may have a specific surface area of at least 1.5 m²/g, such as at least 1.6 m²/g, at least 1.7 m²/g, or at least 1.8 m²/g. The support may have a specific surface area of up to 3 m²/g, such as up 2.75 m²/g, up to 2.5 m²/g, up to 2.25 m²/g, or up to 2.1 m²/g. The support may have a specific surface area of from 1.5 to 3 m²/g, such as from 1.6 to 2.75 m²/g, from 1.7 to 2.5 m²/g, from 1.8 to 2.25 m²/g, or from 1.8 to 2.1 m²/g. The support advantageously provides improved selectivity, and increased catalyst lifetime. The support also provides reduced degradation of reactants.

The support may have a total pore volume of ≥0.4 cm³/g, such as ≥0.45 cm³/g, ≥0.5 cm³/g, or ≥0.55 cm³/g.

The ceramic material may comprise particle size fraction X and at least one of: particle size fraction Y; and/or particle size fraction Z; and/or residues thereof, and the D10 particle size of particle size fraction Y (when present)<D10 particle size of particle size fraction X<D10 particle size of particle size fraction Z (when present).

The ceramic material may comprise particle size fraction X and at least one of: particle size fraction Y; and/or particle size fraction Z; and/or residues thereof, and the D50 particle size of particle size fraction Y (when present)<D50 particle size of particle size fraction X<D50 particle size of particle size fraction Z (when present).

The ceramic material may comprise particle size fraction X and at least one of: particle size fraction Y; and/or particle size fraction Z; and/or residues thereof, and the D90 particle size of particle size fraction Y (when present)<D90 particle size of particle size fraction X<D90 particle size of particle size fraction Z (when present).

The support may be obtainable from a composition, wherein the composition comprises a ceramic material, wherein the ceramic material comprises particle size fraction X and at least one of particle size fraction Y and/or particle size fraction Z.

It is understood that references throughout to particle size fraction X apply when particle size fraction X is present. Similarly, it is understood that references throughout to particle size fraction Y apply when particle size fraction Y is present; and references to particle size fraction Z apply when particle size fraction Z is present.

The particle size fraction X may have a D50 particle size of at least 1 μm, such as at least 1.5 μm, at least 1.75 μm, or at least 2 μm. The particle size fraction X may have a D50 particle size of up to 10 μm, such as up to 8 μm, up to 6 μm; or up to 4 μm. The particle size fraction X may have a D50 particle size of from 1 to 10 μm, such as from 1.5 to 8 μm, from 1.75 to 6 μm, or from 2 to 4 μm.

The particle size fraction X may have a D10 particle size of at least 0.3 μm, such as at least 0.4 μm, or at least 0.5 μm. The particle size fraction X may have a D10 particle size of up to 5 μm, such as up to 3 μm, or up to 2.8 μm. The particle size fraction X may have a D10 particle size of from 0.3 to 5 μm, such as from 0.4 to 3 μm, or from 0.5 to 2.8 μm.

The particle size fraction X may have a D90 particle size of at least 3 μm, such as at least 4 μm, or at least 5 μm. The particle size fraction X may have a D90 particle size of up to 25 μm, such as up to 20 μm, or up to 15 μm. The particle size fraction X may have a D90 particle size of from 3 to 25 μm, such as from 4 to 20 μm, or from 5 to 15 μm.

The particle size fraction Y may have a D50 particle size of at least 0.2 μm, such as at least 0.3 μm, at least 0.4 μm, or at least 0.5 μm. The particle size fraction Y may have a D50 particle size of up to 1 μm, such as up to 0.9 μm, or up to 0.8 μm. The particle size fraction Y may have a D50 particle size of from 0.2 to 1 μm, such as from 0.3 to 0.9 μm, from 0.4 to 0.8 μm, or from 0.5 to 0.8 μm.

The particle size fraction Y may have a D10 particle size of at least 0.1 μm, such as at least 0.2 μm, or at least 0.3 μm. The particle size fraction Y may have a D10 particle size of up to 0.5 μm, such as up to 0.4 μm, or up to 0.3 μm. The particle size fraction Y may have a D10 particle size of from 0.1 to 0.5 μm, such as from 0.2 to 0.4 μm, or about 0.3 μm.

The particle size fraction Y may have a D90 particle size of at least 1.5 μm, such as at least 1.75 μm, or at least 2 μm. The particle size fraction Y may have a D90 particle size of up to 3 μm, such as up to 2.5 μm, or up to 2 μm. The particle size fraction Y may have a D90 particle size of from 1.5 to 3 μm, such as from 1.75 to 2.5 μm, or about 2 μm.

The particle size fraction Y advantageously increases the crush strength of the support.

The particle size fraction Z may have a D50 particle size of at least 10 μm, such as at least 15 μm, at least 18 μm, or at least 20 μm. The particle size fraction Z may have a D50 particle size of up to 50 μm, such as up to 40 μm, or up to 30 μm. The particle size fraction Z may have a D50 particle size of from 10 to 50 μm, such as from 15 to 40 μm, from 18 to 30 μm, or from 20 to 30 μm.

The particle size fraction Z may have a D10 particle size of at least 4 μm, such as at least 6 μm, at least 8 μm, or at least 10 μm. The particle size fraction Z may have a D10 particle size of up to 30 μm, such as up to 20 μm, or up to 15 μm. The particle size fraction Z may have a D10 particle size of from 4 to 30 μm, such as from 6 to 20 μm, from 8 to 15 μm, or from 10 to 15 μm.

The particle size fraction Z may have a D90 particle size of at least 20 μm, such as at least 25 μm, at least 30 μm, or at least 35 μm. The particle size fraction Z may have a D90 particle size of up to 100 μm, such as up to 80 μm, up to 75 μm; or up to 65 μm. The particle size fraction Z may have a D90 particle size of from 20 to 100 μm, such as from 25 to 80 μm, from 30 to 75 μm, or from 35 to 65 μm.

The particle size fraction Z advantageously increases the total pore volume and specific surface area of the support and increases the selectivity and activity of a catalyst containing a support with a particle size fraction Z as described herein.

The particle size fraction Y, when present, may comprise ceramic particles with a D50 particle size that is ≤40% of the D50 particle size of particle size fraction X, such as ≤30%, ≤20%, ≤10%, or ≤8%. The particle size fraction Z, when present, may comprise ceramic particles with a D50 particle size that is ≥300% of the D50 particle size of particle size fraction X, such as ≥300%, ≥500%, ≥750%, ≥1000%, ≥1250%, or ≥1500%.

The support may be obtainable from a composition, wherein the composition comprises a ceramic material and a pore forming material.

The pore forming material may have a D50 particle size of at least 150 μm, such as at least 200 μm, at least 250 μm, at least 300 μm, at least 350 μm, or at least 400 μm. The pore forming material may have a D50 particle size from 150 to 425 μm, such as from 150 to 400 μm, or from 200 to 350 μm.

The pore forming material may comprise a first pore forming particle size fraction and a second pore forming particle size fraction. The first pore forming particle size fraction may have a D50 particle size of at least 50 μm, such as at least 60 μm, at least 70, at least 80 μm, or at least 90 μm. The first pore forming particle size fraction may have a D50 particle size from 50 to 150 μm, such as from 60 to 140 μm, 70 to 130 μm, 80 to 120 μm, or 90 to 110 μm. The second pore forming particle size fraction may have a D50 particle size of at least 150 μm, such as at least 200 μm, at least 250 μm, at least 300 μm, at least 350 μm, or at least 400 μm. The second pore forming particle size fraction may have a D50 particle size from 150 to 425 μm, such as from 150 to 400 μm, or from 200 to 350 μm.

Further, the pore forming material having a D50 particle size of at least 150 μm in combination with ceramic material of particle size fraction Z as disclosed herein advantageously increases the total pore volume and specific surface area and retains the improved properties of the supports of the invention.

The composition may comprise at least 6 wt % of pore forming material based on the total weight of the composition, such as at least 7 wt %, at least 8 wt %, or at least 9 wt %.

The composition may comprise at least 5 wt % of a first pore forming particle size fraction based on the total weight of the composition, such as at least 6 wt %, at least 7 wt %, or at least 8 wt %. The composition may comprise at least 0.2 wt % of a second pore forming particle size fraction based on the total weight of the composition, such as at least 0.4 wt %, at least 0.6 wt %, or at least 0.7 wt %.

The composition may comprise at least 10 wt % of particle size fraction X based on the total weight of the composition, such as at least 15 wt %, at least 20 wt %, at least 25 wt %, or at least 30 wt %. The composition may comprise up to 50 wt % of particle size fraction X based on the total weight of the composition, such as up to 45 wt %, up to 42 wt %, or up to 40 wt %. The composition may comprise from 10 to 50 wt % of particle size fraction X based on the total weight of the composition, such as from 15 to 45 wt %, from 20 to 42 wt %, from 25 to 40 wt %, or from 30 to 40 wt %.

The composition may comprise at least 0.1 wt % of particle size fraction Y based on the total weight of the composition, such as at least 0.2 wt %, or at least 0.3 wt %. The composition may comprise up to 3 wt % of particle size fraction Y based on the total weight of the composition, such as up to 2.5 wt %, up to 2 wt %, or up to 1.7 wt %. The composition may comprise from 0.1 to 3 wt % of particle size fraction Y based on the total weight of the composition, such as from 0.2 to 2.5 wt %, from 0.3 to 2 wt %, or from 0.3 to 1.7 wt %.

The composition may comprise at least 10 wt % of particle size fraction Z based on the total weight of the composition, such as at least 14 wt %, at least 15 wt %, or at least 16 wt %. The composition may comprise up to 35 wt % of particle size fraction Z based on the total weight of the composition, such as up to 30 wt %, up to 28 wt %, or up to 27 wt %. The composition may comprise from 10 to 35 wt % of particle size fraction Z based on the total weight of the composition, such as from 14 to 30 wt %, from 15 to 28 wt %, or from 16 to 27 wt %.

Advantageously, the composition has an improved processability due to a low viscosity which reduces the time and cost of manufacturing of the supports.

The support may have a drop test result of at least 75% survival, such as at least 80%, at least 85%, or at least 90%. The support advantageously has reduced brittleness, improved attrition, and increased catalyst lifetime.

The support may be for a catalyst for use in a packed-bed reactor for the production of an alkylene oxide. The support may further be in the form of a supported catalyst by further comprising catalytic material. The support may also be in the form of an insert packing member wherein suitably the support is substantially free of catalyst material.

According to a second aspect of the present invention there is provided a supported catalyst for use in a packed-bed reactor for the production of an alkylene oxide comprising a support as described herein.

The supported catalyst may have a drop test result of at least 75% survival, such as at least 80%, at least 85%, or at least 90%.

Advantageously, a support as described herein with a pore size distribution wherein ≤2% of the pores have a size of ≤0.1 μm results in a support with an increased crush strength. Additionally, the support also provides increased selectivity and efficiency to processes when the support is a catalyst. Advantageously, a support as described herein with a specific surface area of at least 1.5 m²/g provides an improved catalyst loading surface such that the cost associated with catalyst loading is reduced. Additionally, the support extends the life of the catalyst by reducing aggregation and deactivation of the catalytic material on the support, and further, improves selectivity and maintains a high efficiency of the catalyst. Advantageously, a support as described herein, with a total pore volume of ≥0.4 cm³/g provides an improved catalyst loading surface such that the cost associated with catalyst loading is reduced. Additionally, the support extends the life of the catalyst by reducing aggregation and deactivation of the catalytic material on the support

Advantageously, a support as described herein with a particle size fraction Y, when present, comprising ceramic particles with a D50 particle size that is ≤40% of the D50 particle size of particle size fraction X has increased crush strength, increased total pore volume, reduced brittleness, reduced attrition, and an improved drop test. The support also provides a catalyst with an increased reactivity and catalyst lifetime. The same advantages are observed when the support according to the invention has a particle size fraction Y comprising ceramic particles with a D50 particle size of up to 1 μm.

Advantageously, a support as described herein with a particle size fraction Z, when present, comprises ceramic particles with a D50 particle size that is ≥300% of the D50 particle size of particle size fraction X has increased total pore volume and specific surface area. Further, the support also provides a catalyst with improved reactivity, increased catalyst lifetime and maintains the catalysts high efficiency, whilst reducing catalyst production costs. The same advantages are observed when the support according to the invention has a particle size fraction Z comprising ceramic particles with a D50 particle size of at least 15 μm.

The supports described herein also advantageously have an increased attrition and low brittleness, and an increased catalyst lifetime.

The support/supported catalyst suitably has a macrostructure and surface structures on the outer face of the macrostructure.

The spherical or ellipsoidal macrostructure may comprise at least one linear groove on the outer face of the macrostructure, such as at least two, at least three or at least four linear grooves. Preferably, the spherical or ellipsoidal macrostructure comprises at least two linear parallel grooves, such as at least three or at least four. Preferably, the grooves are substantially hemispherical in a lateral cross-section. When a spherical or ellipsoidal macrostructure comprises such a linear groove the macrostructure can be considered to be a grooved sphere or ellipsoid.

The macrostructure may substantially be in the form of a sphere.

Advantageously, a support as described herein has improved heat transfer and reduces pressure drop across the support. The uniform packing of a support as described herein further reduces the pressure drop across the support thereby reducing operating costs. The supports also show an increased lifetime and increased attrition.

The support/supported catalyst may not comprise a fluid communication intra-particle channel extending through the support/supported catalyst from a first aperture on a first side of the support/supported catalyst to a second aperture on a substantially opposing second side of the support/supported catalyst.

When the support/supported catalyst does not comprise a fluid communication intra-particle channel, fluid may substantially not be able to flow through the support/supported catalyst in use from a first side of the support/supported catalyst to a substantially opposite second side of the support/supported catalyst. Accordingly, to pass the support/supported catalyst fluid may be forced to flow around the outer surface of the support/supported catalyst. As such, in the context of the present invention, the phrase “does not comprise a fluid communication intra-particle channel extending through the support/supported catalyst from a first aperture on a first side of the support/supported catalyst to a second aperture on a substantially opposing second side of the support/supported catalyst” may be interpreted to mean that substantially no fluid flow is achieved through the body of the support/supported catalyst in use from a first side of the support/supported catalyst to a substantially opposite second side of the support/supported catalyst. It will be understood that such “fluid communication intra-particle channels” in the context of the present invention do not include microscopic porosity that may be present in the material of the support/supported catalyst.

The support/supported catalyst may comprise no fluid communication intra-particle channels in the support/supported catalyst extending from a first aperture to a second aperture.

Advantageously, it has surprisingly been found that the combination of surface structures with the absence of a flow channel through the body of the support/supported catalyst leads to increased strength while also increasing flow speed, directing flow over the surface and providing a more uniform flow for the production of an alkylene oxide.

The support/supported catalyst may have a largest dimension of up to 20 mm, such as up to 17 mm, up to 12 mm, up to 9 mm, up to 7 mm or up to 6 mm.

The height, suitably the mean average height, of the surface structures of the support/supported catalyst may be up to 30% of the largest dimension of the support/supported catalyst, such as up to 20%, preferably up to 15%.

By “surface structures” it is meant structures that represent a deviation of the shape of the outer surface of the support/supported catalyst from the shape that would be expected based on the macrostructure of the support/supported catalyst. Such surface structures may be significantly smaller than the size of the features of the macrostructure of the support/supported catalyst. The surface structures may be considered to be surface texturing on the macrostructure of the support/supported catalyst. It will be understood that such “surface structures” in the context of the present invention do not include microscopic surface roughness.

For example, the support/supported catalyst may have a spherical macrostructure with a diameter of 10 mm. The outer surface of the said support/supported catalyst is partially consistently curved as would be expected for a spherical macrostructure, but the outer surface of the support/supported catalyst also comprises a plurality of surface structures that deviate from the expected curved shape of the outer surface in the form of 12 discrete mounds wherein each mound has a height of 2 mm.

It will be appreciated that normal features of macrostructures such as the castellations of a cog or the lobes of multilobe are considered to be part of the macrostructure and are not considered to be surface structures according to the present invention.

The support/supported catalyst may comprise surface structures on at least two sides of the support/supported catalyst.

The support/supported catalyst may comprise surface structures extending over ≥20% of the outer surface of the support/supported catalyst, such as over ≥30%, ≥40%, ≥60% or ≥80% of the outer surface.

By “comprise surface structures extending over”, it is meant that at least the specified percentage of the outer surface of the support/supported catalyst deviates from the expected shape of the outer surface of the support/supported catalyst based on the macrostructure. It will be appreciated that the amount of the surface that deviates is calculated based on the surface area of the expected shape of the outer surface, and missing portions thereof, rather than on the surface area of the surface structures. For example, the support/supported catalyst may have a spherical macrostructure with an expected outer surface area of 314 cm², of which 200 cm² deviates from the expected consistent curvature of a spherical macrostructure, and as such the support/supported catalyst comprises surface structures extending over 63% of the outer surface. For the purposes of this calculation, the expected outer surface area that is occupied by any apertures connecting a fluid communication channel is added to the sum of the remaining expected outer surface area.

The height, suitably the mean average height, of the surface structures of the support/supported catalyst may be ≤10 mm, preferably ≤7 mm, more preferably ≤6 mm, most preferably ≤5 mm. The height, suitably the mean average height, of the surface structures of the support/supported catalyst may be ≥0.1 mm, such as ≥0.3 mm, preferably ≥0.5 mm, more preferably ≥0.7 mm, most preferably ≥0.8 mm. The height of the surface structures herein is measured using calipers with a depth measurement function. It will be appreciated that “height” in this context refers to the distance from the lowest point of the surface structure to the highest point of the surface structure.

The support/supported catalyst may comprise a plurality of repeating surface structures having substantially the same shape. Preferably, the support/supported catalyst comprises at least 5 repeating surface structures, more preferably at least 10, such as at least 15, or at least 20, most preferably at least 25.

A surface structure may be in the form of a ridge, trough, mound and/or depression.

A surface structure in the form of a ridge or trough is typically elongate and may be in the form of an annular ridge/trough, wherein said annular ridge/trough is not restricted to a circular ring shape. The annular ridge/trough may be in the form of a substantially circular shape or a regular convex polygon, such as a triangle, square, pentagon, hexagon, heptagon, octagon, nonagon, or decagon. Preferably the annular ridge/trough is in the form of a regular convex polygon, more preferably pentagon, hexagon or heptagon, most preferably hexagon. The portion of the outer surface that is contained within an annular ridge/trough may be according to the expected shape of the outer surface of the supported catalyst or may be flat, sloped and/or curved. For example, the portion of the outer surface contained within an annular ridge may be in the form of an inverted pyramid. The surface structures may comprise a plurality of connected annular ridge/trough structures, suitably interconnected annular ridge/trough structures such that a ridge of at least a first annular surface structure forms part of a second annular surface structure.

A surface structure in the form of a mound or depression may be a curved, pyramidal and/or stepped mound/depression. A stepped mound/depression may comprise between 2 to 10 steps, such as between 3 and 8 steps. The mound or depression may interconnect such that adjacent mounds/depressions abut or are merged together.

The support/supported catalyst, such as a support/supported catalyst having a diameter or largest dimension of ≥8 mm, or >9 mm, such as ≤17 mm to ≥8 mm, or packed bed, may have a geometric surface area per volume (GSA) of ≥0.7 cm²/cm³, such as a GSA of ≥1 cm²/cm³, preferably a GSA of ≥1.2 cm²/cm³, more preferably a GSA of ≥1.3 cm²/cm³, most preferably a GSA of ≥1.4 cm²/cm³.

The support/supported catalyst, such as a support/supported catalyst having a diameter or largest dimension of ≥8 mm, or >9 mm, such as ≤17 mm to ≥8 mm, may have a side crush strength of ≥5 kgf, such as ≥6 kgf, preferably ≥7 kgf, more preferably ≥8 kgf, most preferably ≥10 kgf, such as ≥50 kgf, such as ≥60 kgf, preferably ≥70 kgf, more preferably ≥80 kgf, most preferably ≥85 kgf.

The support/supported catalyst, such as a support/supported catalyst having a diameter or largest dimension of ≤9 mm, such as ≤9 mm to ≥7 mm, or packed bed, may have a GSA of ≥1.3 cm²/cm³, such as ≥1.4 cm²/cm³, preferably a GSA of ≥1.5 cm²/cm³, more preferably a GSA of ≥1.6 cm²/cm³, most preferably a GSA of ≥1.7 cm²/cm³.

The support/supported catalyst, such as a support/supported catalyst having a diameter or largest dimension of ≤9 mm, such as ≤9 mm to ≥7 mm, may have a side crush strength of ≥3 kgf, preferably ≥4 kgf, more preferably ≥5 kgf, most preferably ≥6 kgf or ≥7 kgf, such as ≥30 kgf, preferably ≥50 kgf, more preferably ≥60 kgf, most preferably ≥70 kgf or ≥80 kgf.

The support/supported catalyst, such as a support/supported catalyst having a diameter or largest dimension of ≤7 mm, such as ≤7 mm to ≥5 mm, or packed bed, may have a GSA of ≥1.7 cm²/cm³, such as ≥1.8 cm²/cm³, preferably a GSA of ≥1.9 cm²/cm³, more preferably a GSA of ≥2.0 cm²/cm³, most preferably a GSA of ≥2.1 cm²/cm³.

The support/supported catalyst, such as a support/supported catalyst having a diameter or largest dimension of ≤7 mm, such as ≤7 mm to ≥5 mm, may have a side crush strength of ≥3 kgf, preferably ≥4 kgf, more preferably ≥5 kgf, most preferably ≥6 kgf or ≥7 kgf, such as ≥30 kgf, preferably ≥40 kgf, more preferably ≥50 kgf, most preferably ≥60 kgf or ≥70 kgf.

The support/supported catalyst, such as a support/supported catalyst having a diameter or largest dimension of ≤10 mm to ≥5 mm, or packed bed, may have a GSA of ≥1.2 cm²/cm³, such as ≥1.5 cm²/cm³, preferably a GSA of ≥1.7 cm²/cm³, more preferably a GSA of ≥1.9 cm²/cm³, most preferably a GSA of ≥2.1 cm²/cm³.

The support/supported catalyst, such as a support/supported catalyst having a diameter or largest dimension of ≤10 mm to ≥5 mm, may have a side crush strength of ≥3 kgf, preferably ≥5 kgf, more preferably ≥7 kgf, most preferably ≥8 kgf or ≥9 kgf, such as ≥30 kgf, preferably ≥50 kgf, more preferably ≥70 kgf, most preferably ≥80 kgf or ≥90 kgf.

The support/supported catalyst, such as a support/supported catalyst having a diameter or largest dimension of ≥8 mm, or >9 mm, such as ≤17 mm to ≥8 mm, may have a GSA of ≥0.7 cm²/cm³ and a side crush strength of ≥5 kgf, such as ≥5 kgf. Within this range, the support/supported catalyst may have a geometric surface area per volume (GSA) of ≥0.7 cm²/cm³, such as a GSA of ≥1 cm²/cm³, preferably a GSA of ≥1.2 cm²/cm³, more preferably a GSA of ≥1.3 cm²/cm³, most preferably a GSA of ≥1.4 cm²/cm³, and a side crush strength of ≥6 kgf, preferably ≥7 kgf, more preferably ≥8 kgf, most preferably ≥10 kgf, such as ≥60 kgf, preferably ≥70 kgf, more preferably ≥80 kgf, most preferably ≥85 kgf.

The support/supported catalyst, such as a support/supported catalyst having a diameter or largest dimension of ≤9 mm, such as ≤9 mm to ≥7 mm, may have a GSA of ≥1.3 cm²/cm³ and a side crush strength of ≥30 kgf. Within this range, the support/supported catalyst may have a GSA of ≥1.4 cm²/cm³, preferably a GSA of ≥1.5 cm²/cm³, more preferably a GSA of ≥1.6 cm²/cm³, most preferably a GSA of ≥1.7 cm²/cm³ and a side crush strength of ≥4 kgf, preferably ≥5 kgf, more preferably ≥6 kgf, most preferably ≥8 kgf, such as ≥50 kgf, preferably ≥60 kgf, more preferably ≥70 kgf, most preferably ≥80 kgf.

The support/supported catalyst, such as a support/supported catalyst having a diameter or largest dimension of ≤7 mm, such as ≤7 mm to ≥5 mm, may have a GSA of ≥1.7 cm²/cm³ and a side crush strength of ≥3 kgf, such as ≥30 kgf. Within this range, the support/supported catalyst may have a GSA of ≥1.8 cm²/cm³, preferably a GSA of ≥1.9 cm²/cm³, more preferably a GSA of ≥2.0 cm²/cm³, most preferably a GSA of ≥2.1 cm²/cm³ and a side crush strength of ≥4 kgf, preferably ≥5 kgf, more preferably ≥6 kgf, most preferably ≥7 kgf, such as ≥40 kgf, preferably ≥50 kgf, more preferably ≥60 kgf, most preferably ≥70 kgf.

The support/supported catalyst, such as a support/supported catalyst having a diameter or largest dimension of ≤10 mm to ≥5 mm, or packed bed, may have a GSA of ≥1.2 cm²/cm³ and a side crush strength of ≥3 kgf, such as ≥30 kgf. Within this range, the support/supported catalyst may have a GSA of ≥1.5 cm²/cm³, preferably a GSA of ≥1.7 cm²/cm³, more preferably a GSA of ≥1.9 cm²/cm³, most preferably a GSA of ≥2.1 cm²/cm³ and a side crush strength of ≥5 kgf, more preferably ≥7 kgf, most preferably ≥8 kgf or ≥9 kgf, such as ≥50 kgf, more preferably ≥70 kgf, most preferably ≥80 kgf or ≥90 kgf.

GSA per volume herein is calculated by measuring the external dimensions of the support/supported catalyst, including all macrostructure and surface structure features and calculating the surface area. The calculated surface area is then divided by the calculated volume of the support/supported catalyst. Suitable 3D modelling software can be used to provide these calculations.

Side crush strength herein is represented by a value given in kgf. This is the maximum load recorded at the point of failure of the sample when pressed & crushed between two parallel, flat, hardened steel plates of a minimum diameter of 80 mm. One plate is fixed to a load cell & recording device, and the other is attached to a ram which moves at a controlled rate of 5 mm/minute. Initial trial tests are carried out to determine the dimension in which the support/supported catalyst is weakest. The side crush test is then carried out in the weakest direction.

Total pore volume, pore size and pore size distribution as used herein were measured by mercury intrusion porosimetry, using ASTM D4284-12(2017)e1, Standard Test Method for Determining Pore Volume Distribution of Catalysts and Catalyst Carriers by Mercury Intrusion Porosimetry. It is understood that references to pore size are references to pore diameter.

Specific surface area as used herein was measured with BET analysis, using ASTM-D3663-20, “Standard Test Method for Surface Area of Catalysts and Catalyst Carriers”.

Particle size including D10 particle size, D50 particle size, D90 particle size and particle size distributions as used herein were measured by laser diffraction, using the Particle Size Analyser “Malvern Mastersizer 3000” with an EV cell attachment.

Advantageously, the support/supported catalyst of the present invention provides improved uniformity in the void space within a packed column while also significantly reducing the flow dead zone relative to the pellet volume. The support/supported catalysts can further provide a combination of desirable properties including high selectivity (such as >90%), long lifetime (such as 3-4 years), low cost, high attrition and/or high crush strength as desired. Furthermore, the support/supported catalyst provides improved mass transport. The use of high GSA supports increases the activity while keeping the selectivity as high as needed, increasing yield, and thereby increasing plant production rates.

The support/supported catalyst of the present invention can also provide an improved geometric surface area whilst still providing improved strength in the production of an alkylene oxide. The support/supported catalyst of the present invention may provide improved geometric surface area in combination with excellent strength and high total pore volume. The improved geometric surface area of the support/supported catalyst is particularly advantageous for applications in which the catalytic reaction is surface based. Supports/Supported catalysts of the present invention can also provide a high heat transfer co-efficient in combination with other improved properties.

The support/supported catalyst of the present invention may be a cast support/supported catalyst, such as a gel cast support/supported catalyst, suitably by slip casting. Preferably, the surface structures of the support/supported catalyst are formed during the moulding step of the support/supported catalyst, i.e. the step in which the green body of the support/supported catalyst is formed, suitably by appropriate formations provided in the shape of the mould. As such, preferably the surface structures are not post-fabricated after the moulding of the green body of the support/supported catalyst.

The support/supported catalyst may be obtainable by gel casting a composition comprising a ceramic material, an organic binder component and optionally a pore forming material.

The support/supported catalyst may be formed from a cast moulding composition, preferably a gel cast moulding composition. The support/supported catalyst may be formed from a moulding composition comprising an organic binder component, a ceramic material, and optionally a pore forming material.

The organic binder component may be operable to be substantially removed from the support/supported catalyst after moulding of the support/supported catalyst, preferably with heat treatment, more preferably removed during calcination of the support/supported catalyst.

The organic binder component may comprise a polymerisable component, suitably including a polymerisable monomer and a crosslinking member, wherein the binder component is operable to polymerise to form a (co) polymer.

The polymerisable monomer may comprise one or more type of ethylenically unsaturated monomers, such as an acrylic monomer or derivative thereof such as an acrylamide monomer, and/or a vinyl monomer, such as a monomer selected from one or more of methacrylamide (MAM), N-(hydroxymethyl) acrylamide (hMAM), hydroxyethyl acrylamide (hEAM) and/or N-vinyl-2-pyrrolidinone (NVP). Preferably, the polymerisable monomer comprises one or more acrylamide monomers, more preferably a monomer selected from one or more of methacrylamide (MAM), N-(hydroxymethyl) acrylamide (hMAM) and hydroxyethyl acrylamide (hEAM). Most preferably, the polymerisable monomer comprises MAM.

The crosslinking member may be selected from one or more of a diethylenically unsaturated monomer, such as a diacrylic monomer or derivative thereof such as a diacrylamide monomer; an acrylic salt and/or a polyethylene glycol substituted acrylic monomer. The crosslinking member may be selected from one or more of poly(ethylene glycol) dimethacrylate (PEGDMA), N,N′-methylenebis(acrylamide) (BIS), ammonium acrylate and PEG methylethylmethacrylate (PEGMEM), preferably one more of poly(ethylene glycol) dimethacrylate (PEGDMA), and N,N′-methylenebis(acrylamide) (BIS).

The organic binder component may be formed from 40 to 95 wt % of polymerisable monomer and from 60 to 5 wt % of crosslinking member, such as from 50 to 90 wt % of polymerisable monomer and from 50 to 10 wt % of crosslinking member, or from 55 to 85 wt % of polymerisable monomer and from 45 to 15 wt % of crosslinking member, or from 60 to 80 wt % of polymerisable monomer and from 40 to 20 wt % of crosslinking member, such as from 65 to 75 wt % of polymerisable monomer and from 35 to 25 wt % of crosslinking member.

The composition may further comprise a polymerisation accelerator, operable to accelerate the polymerisation of the binder component. The polymerisation accelerator may be any suitable accelerator. For example, the accelerator may be tetramethylethylenediamine (TEMED).

The composition may further comprise an initiator operable to initiate polymerisation of the binder component. The initiator may be any suitable initiator. The initiator may be a free radical initiator. For example, the initiator may be ammonium persulphate and/or potassium persulphate.

The pore forming material may be operable to be removed from the supported catalyst after moulding of the support/supported catalyst, preferably with heat treatment, more preferably during calcination of the support/supported catalyst. The pore forming material may be any suitable pore forming material known in the art. The pore forming material may be selected from one or more of microbeads, starch, seeds and/or cellulose.

The ceramic material of the support/supported catalyst or composition may be a refractory ceramic material. The ceramic material may comprise aluminium oxide, aluminium silicate, magnesium aluminate, calcium aluminate, zirconia, silica, titanate, carbon and/or magnesium oxide, or precursors thereof. The ceramic material may comprise aluminium oxide, calcium aluminate or precursors thereof. The ceramic material may comprise aluminium oxide, such as α-aluminium oxide, or precursors thereof.

The ceramic material may have a particle size distribution wherein D10 is from 0.1 to 20 μm, preferably from 0.5 to 10 μm, more preferably from 1 to 5 μm, most preferably from 1.5 to 3 μm. The D50 of the ceramic material may be from 0.5 to 30 μm, preferably from 1 to 25 μm, more preferably from 1.5 to 20 μm, most preferably from 2 to 15 μm. The D90 of the ceramic material may be from 10 to 100 μm, preferably from 15 to 80 μm, more preferably from 20 to 70 μm, most preferably from 25 to 60 μm.

The ceramic material may be a ceramic powder. The ceramic powder may be ball milled or spray dried. Advantageously, it has been found that ball milled or spray dried ceramic powder provides easier casting behaviour.

The composition or support/supported catalyst may comprise a promoter, operable to increase the reactivity of the main reaction, and/or decrease undesirable side reactions. The promoter may be selected from one or more of oxides of lanthanum, copper, magnesium, manganese, potassium, calcium, zirconium, barium, cerium, sodium, lithium, molybdenum, yttrium, cobalt, and chromium. The promoter may be selected from one or more of oxides of lanthanum, copper, magnesium, calcium, zirconium, rhenium, tungsten and molybdenum.

The composition may further comprise a carrier, such as an aqueous carrier. Suitably the composition is an aqueous ceramic slurry.

The composition may comprise further additives. For example, the composition may comprise a dispersant, such as a polymeric salt, for example a salt of a polyacrylic, preferably an ammonium salt of a polyacrylic. A suitable dispersant may be selected from one or more of Ecodis P90, Narlex LD42 and Dispex A40.

The composition may comprise from 0.1 to 10% of polymerisable monomer by dry weight of the composition, preferably from 0.5 to 8 wt %, more preferably from 1 to 6 wt %, such as from 1.5 to 5 wt %, most preferably from 2 to 4 wt %.

The composition may comprise from 0.1 to 10% of crosslinking member by dry weight of the composition, preferably from 0.5 to 8 wt %, more preferably from 0.75 to 6 wt %, such as from 1 to 5 wt %, most preferably from 1 to 4 wt %.

The composition may comprise from 50 to 95% of ceramic material by dry weight of the composition, preferably from 50 to 90 wt %, more preferably from 55 to 85 wt %, most preferably from 60 to 80 wt %. The supported catalyst may comprise at least 75% of ceramic material by dry weight of the composition, preferably at least 85 wt %, more preferably at least 90 wt %, such as at least 95 wt %, most preferably at least 97 wt % ceramic material.

The ceramic material of the support/supported catalyst or composition may comprise ≥50% aluminium oxide by weight of the ceramic material, such as ≥75 wt % aluminium oxide, or ≥90 wt % aluminium oxide, ≥95 wt % aluminium oxide, or ≥99 wt % aluminium oxide.

The support/supported catalyst may comprise ≥50% aluminium oxide by weight of the ceramic material, such as ≥75 wt % aluminium oxide, or ≥80 wt % aluminium oxide, ≥85 wt % aluminium oxide, or ≥90 wt % aluminium oxide.

The composition may comprise from >0 to 40% of pore forming member by dry weight of the composition, preferably from 0.5 to 30 wt %, more preferably 2 to 25 wt %, such as from 3 to 20 wt %, most preferably from 4 to 15 wt %.

The composition may comprise from 0.1 to 5% of initiator by dry weight of the composition, preferably from 0.5 to 4 wt %, more preferably from 0.75 to 3.5 wt %, most preferably from 1 to 3 wt %.

The composition may comprise up to 5% of accelerator by dry weight of the composition, preferably up to 3 wt %, more preferably up to 2 wt %, most preferably up to 1.5 wt %.

The composition may comprise from 0.1 to 10% of dispersant by dry weight of the composition, preferably from 0.5 to 8 wt %, more preferably 0.75 to 6 wt %, most preferably from 1 to 5 wt %.

The composition may have a solids content of from 45 to 99% by total weight of the composition, such as from 50 to 95 wt %, preferably from 55 to 90 wt %, most preferably from 60 to 85 wt %.

The composition may be formed by combining a pre-formed aqueous binder component with a ceramic composition. Suitably the aqueous binder component comprises a polymerisable monomer, a crosslinking member and water.

The supported catalyst of the present invention comprises catalytic material. The catalytic material is operable to provide catalytic activity in the production of an alkylene oxide.

The catalytic material may comprise a metal, such as a noble metal, for example gold, platinum, rhodium, palladium, ruthenium, rhenium, and/or silver; and/or a base metal such as copper, chromium, iron, cobalt, nickel, zinc, manganese, vanadium, titanium and/or scandium. Typically, the catalytic material may comprise a noble metal, such as silver.

The supported catalyst may comprise catalytic material in an amount of ≥5% by weight of the supported catalyst, such as ≥7 wt % or ≥10 wt %. The supported catalyst may comprise catalytic material in an amount of ≤50% by weight of the supported catalyst, such as ≤40 wt % or ≤20 wt %. The supported catalyst may comprise catalytic material in an amount of from 5 to 30% by weight of the supported catalyst, such as from 7 to 25 wt % or from 10 to 20 wt %.

The support/supported catalyst may be for use in a packed-bed reactor for the production of an alkylene oxide such as ethylene oxide, 1,9-decadiene oxide, 1,3-butadiene oxide, 2-butene oxide, isobutylene oxide, 1-butene oxide and/or propylene oxide, suitably for ethylene oxide.

According to a third aspect of the present invention there is provided a method for producing a support and optionally a supported catalyst, suitably a support or supported catalyst according to the first or second aspect of the present invention, comprising the steps of:
a. contacting a composition for producing a support/supported catalyst, suitably a gel cast composition as defined in relation to the first and second aspect, with an initiator and optionally a polymerisation accelerator;
b. arranging the resulting composition of step (a) in a mould;
c. demoulding the composition to produce a green body,
d. optionally, drying the green body at room temperature or baking the green body at elevated temperature;
e. calcining the green body;
f. optionally, contacting the support with catalytic material.

The composition may be mixed before arranging in the mould to form a homogeneous slurry, suitably before addition of initiator and the optional accelerator. The composition may be mixed after addition of the initiator and the optional accelerator to form a homogeneous slurry.

The mould is preferably a cast mould. The mould may be operable to form surface structures on the green body.

The green body produced by step (c) may be dried by baking the green body at ≥60° C., such as ≥70° C. or ≥90° C. or ≥100° C. Suitably, the green body may be baked for ≥10 hours, such as ≥15 hours or ≥20 hours, for example ≥24 hours.

The green body may be calcined at ≥1000° C., preferably ≥1200° C., more preferably ≥1400° C., most preferably ≥1450° C. Suitably, the green body is fired until substantially all of the binder and pore forming material has been removed from the support/supported catalyst.

Advantageously, the present invention enables the green support/supported catalyst body to be removed from the mould while it is in a form that is still relatively rubbery, allowing for easier handling. This leads to a lower scrap rate than other types of casting techniques.

The catalytic material may be arranged onto the support by any suitable method. The catalytic material may be applied by solution impregnation, physical vapor deposition, chemical vapor deposition or other suitable technique. Typically, by solution impregnation.

An aqueous solution of the catalytic material may be used. For example, a suitable solution may comprise a solution of a silver lactate or silver oxalate (for example through reaction of silver hydroxide with oxalic acid, or reaction of silver nitrate or silver oxide with ammonium oxalate). The surface tension of the solution may be adjusted with a suitable surfactant, such as laurylamine ethoxylate. The solution may have a surface tension of <50 mN/m.

The solution may be applied to the support by dipping the support into the solution. The support may be dried at a temperature of from 105° to 150° C. The support may then be calcined, suitably in air, for example at a temperature of from 550 to 600° C.

The catalytic material may be arranged directly on the surface of the support or may be bound to an intermediate layer, such as a washcoat. The catalytic material may also be covalently attached to a macromolecular species, such as a synthetic polymer or a biopolymer, such as a protein or nucleic acid polymer, which may then be arranged either directly to the surface of the support or on an intermediate layer.

The solution or support/supported catalyst may comprise an amino compound, which may act as a complex forming agent. The inclusion of an amino compound can improve decomposition of the metal salts into well dispersed and fine particles. The amino compound may be selected from ethyldiamine, monoethanolamine and/or diethanolamine.

The solution or support/supported catalyst may comprise an additive, such as a promoter. As used herein, “a promoter” can be considered to be a component that improves an aspect of catalyst performance or otherwise promote the production of the desired product. A promoter is not typically a catalytic material.

The promoter may be selected from an alkali metal or alkali earth metal, such as rubidium, potassium, lithium, sodium, and/or caesium; and/or from a transition metal, such as rhenium, molybdenum, tungsten and/or manganese. The promoter may be selected from an alkali metal or alkali earth metal, such as a transition metal, such as rhenium, molybdenum, tungsten and/or manganese. Suitably, the promoter may be selected from rubidium and/or caesium.

The solution may comprise a promoter in an amount of from 0.01 to 0.05% by weight of the solution.

According to a fourth aspect of the present invention there is provided a method for producing a support or a supported catalyst, suitably a support or supported catalyst according to the first or second aspect of the present invention, the method comprising the steps of:
a. optionally, producing a digital model of a support/supported catalyst;
b. producing a precursor according to the model using additive manufacturing, preferably printing with a 3D printer;
c. forming a cast mould from the precursor;
d. cast moulding a moulding composition, suitably a moulding composition as defined in relation to the first or second aspect, to form a support or supported catalyst; suitably according to the method of the third aspect of the present invention.

According to a fifth aspect of the present invention there is provided a reactor for the production of an alkylene oxide comprising a catalyst bed wherein the catalyst bed comprises a support according to the first aspect of the present invention and/or a supported catalyst according to the second aspect of the present invention.

The reactor may comprise a plurality of reactor tubes comprising a support and/or supported catalyst according to the present invention, suitably ≥500 reactor tubes, such as ≥1000 reactor tubes.

According to a sixth aspect of the present invention there is provided a reactor tube for the production of an alkylene oxide comprising a catalyst bed wherein the catalyst bed comprises a support according to the first aspect of the present invention and/or a supported catalyst according to the second aspect of the present invention.

The reactor tube may have a height of from 2 to 25 meters, such as from 4 to 20 meters or from 6 to 15 meters. The reactor tubes may have a diameter of from 5 to 100 mm, such as from 10 to 75 mm or from 15 to 60 mm.

According to a seventh aspect of the present invention there is provided a reaction medium for the production of an alkylene oxide comprising a catalyst bed wherein the catalyst bed comprises a support according to the first aspect of the present invention and/or a supported catalyst according to the second aspect of the present invention.

The reaction medium may further comprise an alkylene and oxygen or air. The alkylene may be selected from ethylene, 1,9-decadiene, 1,3-butadiene, 2-butene, isobutylene, 1-butene and/or propylene, suitably ethylene.

The reaction medium may comprise a diluent, such as methane, argon and/or N₂, suitably methane and/or argon when oxygen is used and N₂ when air is used.

The reaction medium may further comprise carbon dioxide.

The reaction medium may have a temperature of from 200 to 300° C., such as from 200 to 275° C., or from 240 to 275° C.

The reaction medium may have a pressure of from 1 to 3 MPa.

The reaction medium may have a gas hourly space velocity (GHSV) of from 2,000 to 4,500 h⁻¹.

According to an eighth aspect of the present invention, there is provided a method for the production of an alkylene oxide comprising the use of a reactor comprising a catalyst bed wherein the catalyst bed comprises a support according to the first aspect of the present invention and/or a supported catalyst according to the second aspect of the present invention to produce an alkylene oxide.

The method may comprise contacting an alkylene and oxygen/air with the supported catalyst. The alkylene may be selected from ethylene, 1,9-decadiene, 1,3-butadiene, 2-butene, isobutylene, 1-butene and/or propylene, suitably ethylene.

The method may comprise forming a reaction medium according to the seventh aspect of the present invention.

According to a ninth aspect of the present invention, there is provided apparatus for the production of an alkylene glycol comprising a reactor for the production of an alkylene oxide according to the fifth aspect of the present invention and a reactor for the production of alkylene glycol using the alkylene oxide produced from the alkylene oxide reactor.

According to a tenth aspect of the present invention, there is provided a method for the production of an alkylene glycol comprising producing an alkylene oxide according to the eighth aspect of the present invention and then using the produced alkylene oxide in the production of the alkylene glycol.

The supports/supported catalysts of the present invention provide numerous improvements compared to commercially available supports/supported catalysts which are not according to the present invention, as disclosed herein.

As used herein, unless otherwise expressly specified, all numbers such as those expressing values, ranges, amounts or percentages may be read as if prefaced by the word “about”, even if the term does not expressly appear. The term “about” when used herein means +/−10% of the stated value. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Also, any numerical range recited herein is intended to include all sub-ranges subsumed therein.

Singular encompasses plural and vice versa. For example, although reference is made herein to “an” organic binder component, “a” ceramic material, “a” pore forming material, and the like, one or more of each of these and any other components can be used. As used herein, the term “polymer” refers to oligomers and both homopolymers and copolymers, and the prefix “poly” refers to two or more. Including, for example and like terms means including for example but not limited to. The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the processes, materials, and coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

Where ranges are provided in relation to a genus, each range may also apply additionally and independently to any one or more of the listed species of that genus. For example, the composition may comprise from 0.1 to 10% of polymerisable monomer, by total dry weight of the composition, which polymerisable monomer comprises methacrylamide in an amount such that the composition comprises from 0.1 to 10% of methacrylamide, by total dry weight of the composition. Similarly, the composition may comprise from 0.1 to 10% of polymerisable monomer, by total dry weight of the composition, which polymerisable monomer comprises methacrylamide and hydroxyethyl acrylamide in an amount such that the composition comprises from 0.1 to 10% of methacrylamide and hydroxyethyl acrylamide, by total dry weight of the composition. A further example may be wherein the composition comprises from 0.1 to 10% of polymerisable monomer, by total dry weight of the composition, which polymerisable monomer comprises methacrylamide and hydroxyethyl acrylamide in an amount such that the composition comprises ≥0.1% of methacrylamide, by total dry weight of the composition. Further, for example, the invention may comprise from 0.1 to 10% of polymerisable monomer, by total solid weight of the composition, which polymerisable monomer comprises methacrylamide and hydroxyethyl acrylamide in an amount such that the composition comprises ≤6% of methacrylamide, by total solid weight of the composition. Further examples of the above mentioned include the ranges provided for the organic binder, the crosslinking member, the ceramic material, the pore forming member, the initiator, the accelerator, and the dispersant, and all associated species, sub-genera and sub species.

The following clauses provide further embodiments of the invention.

### CLAUSES

1. A support for a catalyst, wherein the support comprises surface structures, wherein the support comprises ceramic material; and wherein the support has a pore size distribution wherein ≤2% of the pores have a size of ≤0.1 μm and/or has a specific surface area of at least 1.5 m²/g and/or has a total pore volume of ≥0.4 cm³/g.
2. A support for a catalyst, wherein the support comprises surface structures, and wherein the support comprises a ceramic material wherein the ceramic material comprises particle size fraction X and at least one of:
   particle size fraction Y; and/or
   particle size fraction Z;
   and/or residues thereof;
   wherein particle size fraction Y, when present, comprises ceramic particles with a D50 particle size that is ≤40% of the D50 particle size of particle size fraction X,
   wherein particle size fraction Z, when present, comprises ceramic particles with a D50 particle size that is ≥300% of the D50 particle size of particle size fraction X.
3. A support for a catalyst, wherein the support comprises surface structures, and wherein the support comprises a ceramic material wherein the ceramic material comprises particle size fraction X and at least one of:
   particle size fraction Y comprising ceramic particles with a D50 particle size of up to 1 μm; and/or
   particle size fraction Z comprising ceramic particles with a D50 particle size of at least 15 μm;
   and/or residues thereof;
   wherein the D50 particle size of particle size fraction Y, when present, is smaller than the D50 particle size of particle size fraction X,
   wherein the D50 particle size of particle size fraction Z, when present, is larger than the D50 particle size of particle size fraction X.
4. A support for a catalyst according to any preceding clause, wherein the support is a gel-cast support.
5. A support for a catalyst according to any preceding clause, wherein the support has a substantially spherical and/or ellipsoidal macrostructure.
6. A support for a catalyst according to any preceding clause, wherein the support has a pore size distribution wherein ≤2% of the pores have a size of ≤0.1 μm, such as ≤1.5%, ≤1%, ≤0.75%, or ≤0.5%; and/or wherein the support has a pore size distribution wherein ≤25% of the pores have a size of ≥10 μm, such as ≤20%, ≤15%, ≤10%, or ≤5%.
7. A support for a catalyst according to any preceding clause, wherein the support has a specific surface area of at least 1.5 m²/g, such as at least 1.6 m²/g, at least 1.7 m²/g, at least 1.8 m²/g; and/or has a specific surface area of up to 3 m²/g, such as up 2.75 m²/g, up to 2.5 m²/g, up to 2.25 m²/g, or up to 2.1 m²/g; and/or has a specific surface area of from 1.5 to 3 m²/g, such as from 1.6 to 2.75 m²/g, from 1.7 to 2.5 m²/g, from 1.8 to 2.25 m²/g, or from 1.8 to 2.1 m²/g.
8. A support for a catalyst according to any preceding clause, wherein the support has a total pore volume of ≥0.4 cm³/g, such as ≥0.45 cm³/g, ≥0.5 cm³/g, or ≥0.55 cm³/g.
9. A support for a catalyst according to any preceding clause, wherein the ceramic material comprises particle size fraction X and at least one of:
   particle size fraction Y; and/or
   particle size fraction Z;
   and/or residues thereof,
   and wherein the D50 particle size of particle size fraction Y (when present)<D50 particle size of particle size fraction X<D50 particle size of particle size fraction Z (when present).
10. A support for a catalyst according to any preceding clause, wherein the support is obtainable from a composition, wherein the composition comprises a ceramic material, wherein the ceramic material comprises particle size fraction X and at least one of particle size fraction Y and/or particle size fraction Z.
11. A support for a catalyst according to any preceding clause, wherein particle size fraction X has a D50 particle size of at least 1 μm, such as at least 1.5 μm, at least 1.75 μm, or at least 2 μm; and/or has a D50 particle size of up to 10 μm, such as up to 8 μm, up to 6 μm; or up to 4 μm; and/or has a D50 particle size of from 1 to 10 μm, such as from 1.5 to 8 μm, from 1.75 to 6 μm, or from 2 to 4 μm; and/or
   wherein particle size fraction X has a D10 particle size of at least 0.3 μm, such as at least 0.4 μm, or at least 0.5 μm; and/or has a D10 particle size of up to 5 μm, such as up to 3 μm, up to 2.8 μm; and/or has a D10 particle size of from 0.3 to 5 μm, such as from 0.4 to 3 μm, or from 0.5 to 2.8 μm; and/or
   wherein particle size fraction X has a D90 particle size of at least 3 μm, such as at least 4 μm, or at least 5 μm; and/or has a D90 particle size of up to 25 μm, such as up to 20 μm, or up to 15 μm; and/or has a D90 particle size of from 3 to 25 μm, such as from 4 to 20 μm, or from 5 to 15 μm.
12. A support for a catalyst according to any preceding clause, wherein particle size fraction Y has a D50 particle size of at least 0.2 μm, such as at least 0.3 μm, at least 0.4 μm, or at least 0.5 μm; and/or has a D50 particle size of up to 1 μm, such as up to 0.9 μm, or up to 0.8 μm; and/or has a D50 particle size of from 0.2 to 1 μm, such as from 0.3 to 0.9 μm, from 0.4 to 0.8 μm, or from 0.5 to 0.8 μm; and/or
   wherein particle size fraction Y has a D10 particle size of at least 0.1 μm, such as at least 0.2 μm, or at least 0.3 μm; and/or has a D10 particle size of up to 0.5 μm, such as up to 0.4 μm, up to 0.3 μm; and/or has a D10 particle size of from 0.1 to 0.5 μm, such as from 0.2 to 0.4 μm, or about 0.3 μm; and/or
   wherein particle size fraction Y has a D90 particle size of at least 1.5 μm, such as at least 1.75 μm, or at least 2 μm; and/or has a D90 particle size of up to 3 μm, such as up to 2.5 μm, or up to 2 μm; and/or has a D90 particle size of from 1.5 to 3 μm, such as from 1.75 to 2.5 μm, or about 2 μm.
13. A support for a catalyst according to any preceding clause, wherein particle size fraction Z has a D50 particle size of at least 10 μm, such as at least 15 μm, at least 18 μm, or at least 20 μm; and/or has a D50 particle size of up to 50 μm, such as up to 40 μm, or up to 30 μm; and/or has a D50 particle size of from 10 to 50 μm, such as from 15 to 40 μm, from 18 to 30 μm, or from 20 to 30 μm; and/or
   wherein particle size fraction Z has a D10 particle size of at least 4 μm, such as at least 6 μm, or at least 8 μm, or at least 10 μm; and/or has a D10 particle size of up to 30 μm, such as up to 20 μm, or up to 15 μm; and/or has a D10 particle size of from 4 to 30 μm, such as from 6 to 20 μm, from 8 to 15 μm, or from 10 to 15 μm; and/or
   wherein particle size fraction Z has a D90 particle size of at least 20 μm, such as at least 25 μm, at least 30 μm, or at least 35 μm; and/or has a D90 particle size of up to 100 μm, such as up to 80 μm, up to 75 μm; or up to 65 μm; and/or has a D90 particle size of from 20 to 100 μm, such as from 25 to 80 μm, from 30 to 75 μm, or from 35 to 65 μm.
14. A support for a catalyst according to any preceding clause, wherein particle size fraction Y, when present, comprises ceramic particles with a D50 particle size that is ≤40% of the D50 particle size of particle size fraction X, such as ≤30%, ≤20%, ≤10%, or ≤8%; and/or
   wherein particle size fraction Z, when present, comprises ceramic particles with a D50 particle size that is ≥300% of the D50 particle size of particle size fraction X, such as ≥300%, ≥500%, ≥750%, ≥1000%, ≥1250%, or ≥1500%.
15. A support for a catalyst according to any preceding clause, wherein the support is obtainable from a composition, wherein the composition comprises a ceramic material and a pore forming material.
16. A support for a catalyst according to clause 15, wherein the pore forming material has a D50 particle size of at least 150 μm, such as at least 200 μm, at least 250 μm, at least 300 μm, at least 350 μm, at least 400 μm; and/or has a D50 particle size from 150 to 425 μm, such as from 150 to 400 μm, from 200 to 350 μm.
17. A support for a catalyst according to clause 15, wherein the pore forming material comprises a first pore forming particle size fraction and a second pore forming particle size fraction,
   wherein the first pore forming particle size fraction has a D50 particle size of at least 50 μm, such as at least 60 μm, at least 70, at least 80 μm, or at least 90 μm; and/or has a D50 particle size from 50 to 150 μm, such as from 60 to 140 μm, 70 to 130 μm, 80 to 120 μm, or 90 to 110 μm,
   and wherein the second pore forming particle size fraction has a D50 particle size of at least 150 μm, such as at least 200 μm, at least 250 μm, at least 300 μm, at least 350 μm, at least 400 μm; and/or has a D50 particle size from 150 to 425 μm, such as from 150 to 400 μm, from 200 to 350 μm.
18. A support for a catalyst according to any of clauses 15-17, wherein the support is obtainable from a composition and
   wherein the composition comprises at least 6 wt % of pore forming material based on the total weight of the composition, such as at least 7 wt %, at least 8 wt %, or at least 9 wt %; and/or
   wherein the composition comprises at least 5 wt % of a first pore forming particle size fraction based on the total weight of the composition, such as at least 6 wt %, at least 7 wt %, or at least 8 wt %; and wherein the composition comprises at least 0.2 wt % of a second pore forming particle size fraction based on the total weight of the composition, such as at least 0.4 wt %, at least 0.6 wt %, or at least 0.7 wt %.
19. A support for a catalyst according to any preceding clause, wherein the support is obtainable from a composition, and
   wherein the composition comprises at least 10 wt % of particle size fraction X based on the total weight of the composition, such as at least 15 wt %, at least 20 wt %, at least 25 wt %, or at least 30 wt %; and/or up to 50 wt % of particle size fraction X based on the total weight of the composition, such as up to 45 wt %, up to 42 wt %, or up to 40 wt %; and/or from 10 to 50 wt % of particle size fraction X based on the total weight of the composition, such as from 15 to 45 wt %, from 20 to 42 wt %, from 25 to 40 wt %, or from 30 to 40 wt %; and/or
   wherein the composition comprises at least 0.1 wt % of particle size fraction Y based on the total weight of the composition, such as at least 0.2 wt %, or at least 0.3 wt %; and/or up to 3 wt % of particle size fraction Y based on the total weight of the composition, such as up to 2.5 wt %, up to 2 wt %, or up to 1.7 wt %; and/or from 0.1 to 3 wt % of particle size fraction Y based on the total weight of the composition, such as from 0.2 to 2.5 wt %, from 0.3 to 2 wt %, or from 0.3 to 1.7 wt %; and/or
   wherein the composition comprises at least 10 wt % of particle size fraction Z based on the total weight of the composition, such as at least 14 wt %, at least 15 wt %, or at least 16 wt %; and/or up to 35 wt % of particle size fraction Z based on the total weight of the composition, such as up to 30 wt %, up to 28 wt %, up to 27 wt %; and/or from 10 to 35 wt % of particle size fraction Z based on the total weight of the composition, such as from 14 to 30 wt %, from 15 to 28 wt %, or from 16 to 27 wt %.
20. A supported catalyst for use in a packed-bed reactor for the production of an alkylene oxide comprising a support according to any preceding clause; and/or
   wherein the support/supported catalyst is for use in a packed-bed reactor for the production of ethylene oxide, 1,9-decadiene oxide, 1,3-butadiene oxide, 2-butene oxide, isobutylene oxide, 1-butene oxide and/or propylene oxide; and/or
   wherein the support/supported catalyst is for use in a packed-bed reactor for the production of ethylene oxide.
21. A support or supported catalyst according to any preceding clause, wherein the support has a drop test result of at least 75% survival, such as at least 80%, at least 85%, or at least 90%, and wherein the drop test is measured according to the description.
22. A support or supported catalyst according to any preceding clause, wherein the macrostructure of the support/supported catalyst is substantially in the form of a sphere; and/or
   wherein the support/supported catalyst does not comprise a fluid communication intra-particle channel extending through the support/supported catalyst from a first aperture on a first side of the support/supported catalyst to a second aperture on a substantially opposing second side of the support/supported catalyst; and/or
   wherein the support/supported catalyst comprises a plurality of repeating surface structures having substantially the same shape; and/or
   wherein, the support/supported catalyst comprises at least 5 repeating surface structures, more preferably at least 10, such as at least 15, or at least 20, most preferably at least 25; and/or wherein the support/supported catalyst comprises surface structures extending over ≥20% of the outer surface of the support/supported catalyst, such as over ≥30%, ≥40%, ≥60% or ≥80% of the outer surface; and/or wherein the surface structure comprises a ridge, trough, mound and/or depression; and/or
   wherein the surface structure in the form of a ridge or trough is in the form of an annular ridge/trough, wherein optionally the annular ridge/trough is in the form of a substantially circular shape or a regular convex polygon, such as a triangle, square, pentagon, hexagon, heptagon, octagon, nonagon, or decagon; and/or
   wherein the surface structure in the form of a mound or depression is a curved, pyramidal and/or stepped mound/depression.
23. A support or supported catalyst according to any preceding clause, wherein the support/supported catalyst, such as a support/supported catalyst having a diameter or largest dimension of ≥8 mm, or >9 mm, such as ≤17 mm to ≥8 mm, or packed bed, has a geometric surface area per volume (GSA) of ≥0.7 cm²/cm³, such as a GSA of ≥1 cm²/cm³, preferably a GSA of ≥1.2 cm²/cm³, more preferably a GSA of ≥1.3 cm²/cm³, most preferably a GSA of ≥1.4 cm²/cm³; and/or the support/supported catalyst has a side crush strength of ≥5 kgf, such as ≥6 kgf, preferably ≥7 kgf, more preferably ≥8 kgf, most preferably ≥10 kgf, such as ≥50 kgf, such as ≥60 kgf, preferably ≥70 kgf, more preferably ≥80 kgf, most preferably ≥85 kgf; and/or
   wherein the support/supported catalyst, such as a support/supported catalyst having a diameter or largest dimension of ≤9 mm, such as ≤9 mm to ≥7 mm, or packed bed, has a GSA of ≥1.3 cm²/cm³, such as ≥1.4 cm²/cm³, preferably a GSA of ≥1.5 cm²/cm³, more preferably a GSA of ≥1.6 cm²/cm³, most preferably a GSA of ≥1.7 cm²/cm³; and/or the support/supported catalyst has a side crush strength of ≥3 kgf, preferably ≥4 kgf, more preferably ≥5 kgf, most preferably ≥6 kgf or ≥7 kgf, such as ≥30 kgf, preferably ≥50 kgf, more preferably ≥60 kgf, most preferably ≥70 kgf or ≥80 kgf; and/or
   wherein the support/supported catalyst, such as a support/supported catalyst having a diameter or largest dimension of ≤7 mm, such as ≤7 mm to ≥5 mm, or packed bed, has a GSA of ≥1.7 cm²/cm³, such as ≥1.8 cm²/cm³, preferably a GSA of ≥1.9 cm²/cm³, more preferably a GSA of ≥2.0 cm²/cm³, most preferably a GSA of ≥2.1 cm²/cm³; and/or the support/supported catalyst has a side crush strength of ≥3 kgf, preferably ≥4 kgf, more preferably ≥5 kgf, most preferably ≥6 kgf or ≥7 kgf, such as ≥30 kgf, preferably ≥40 kgf, more preferably ≥50 kgf, most preferably ≥60 kgf or ≥70 kgf; and/or
   wherein the support/supported catalyst, such as a support/supported catalyst having a diameter or largest dimension of ≤10 mm to ≥5 mm, or packed bed, wherein the support/supported catalyst has a GSA of ≥1.2 cm²/cm³, such as ≥1.5 cm²/cm³, preferably a GSA of ≥1.7 cm²/cm³, more preferably a GSA of ≥1.9 cm²/cm³, most preferably a GSA of ≥2.1 cm²/cm³; and/or the support/supported catalyst has a side crush strength of ≥3 kgf, preferably ≥5 kgf, more preferably ≥7 kgf, most preferably ≥8 kgf or ≥9 kgf, such as ≥30 kgf, preferably ≥50 kgf, more preferably ≥70 kgf, most preferably ≥80 kgf or ≥90 kgf.
24. A support or supported catalyst according to any preceding clause, wherein the support/supported catalyst is a cast support/supported catalyst, such as a gel cast supported catalyst and/or wherein the support/supported catalyst is obtainable by gel casting a composition comprising a ceramic material, an organic binder component and optionally a pore forming material; optionally wherein the organic binder component comprises a polymerisable component, suitably including a polymerisable monomer and a crosslinking member, wherein the binder component is operable to polymerise to form a (co) polymer; and/or
   wherein the organic binder component is formed from 40 to 95 wt % of polymerisable monomer and from 60 to 5 wt % of crosslinking member, such as from 50 to 90 wt % of polymerisable monomer and from 50 to 10 wt % of crosslinking member, or from 55 to 85 wt % of polymerisable monomer and from 45 to 15 wt % of crosslinking member, or from 60 to 80 wt % of polymerisable monomer and from 40 to 20 wt % of crosslinking member, such as from 65 to 75 wt % of polymerisable monomer and from 35 to 25 wt % of crosslinking member; and/or
   wherein the ceramic material comprises aluminium oxide, aluminium silicate, magnesium aluminate, calcium aluminate, zirconia, silica, titanate, carbon and/or magnesium oxide or precursors thereof; and/or wherein the ceramic material comprises aluminium oxide, calcium aluminate, zirconia or precursors thereof; and/or wherein the composition or support/supported catalyst comprises a promoter, such as a promoter selected from oxides of lanthanum, copper, magnesium, manganese, potassium, calcium, zirconium, barium, cerium, sodium, lithium, molybdenum, yttrium, cobalt, and/or chromium; and/or such as a promoter selected from one or more of oxides of lanthanum, copper, magnesium, calcium, zirconium, rhenium, tungsten, molybdenum; and/or wherein the composition or support/supported catalyst comprises a promoter, such as a promoter selected from oxides of, manganese, calcium, zirconium, molybdenum, rhenium, yttrium; and/or wherein the composition comprises from 0.1 to 10% of polymerisable monomer by dry weight of the composition, preferably from 0.5 to 8 wt %, more preferably from 1 to 6 wt %, such as from 1.5 to 5 wt %, most preferably from 2 to 4 wt %; and/or wherein the composition comprises from 50 to 95% of ceramic material by dry weight of the composition, preferably from 50 to 90 wt %, more preferably from 55 to 85 wt %, most preferably from 60 to 80 wt %.
25. A supported catalyst according to any of clauses 20 to 24, wherein the catalytic material comprises a metal, such as a noble metal, for example gold, platinum, rhodium, palladium, ruthenium, rhenium, and/or silver; and/or a base metal such as copper, chromium, iron, cobalt, nickel, zinc, manganese, vanadium, titanium and/or scandium; and/or
   wherein the catalytic material comprises silver.
26. A method for producing a support or a supported catalyst, suitably a support or supported catalyst according to any of clauses 1 to 25, comprising the steps of:
   a. contacting a composition for producing a support/supported catalyst, suitably a composition, such as a gel-cast composition, as defined in any preceding clause, with an initiator and optionally a polymerisation accelerator;
   b. arranging the resulting composition of step (a) in a mould;
   c. demoulding the composition to produce a green body,
   d. optionally, drying the green body at room temperature or baking the green body at elevated temperature;
   e. calcining the green body;
   f. optionally, contacting the support with catalytic material.
27. A reactor for the production of an alkylene oxide comprising a catalyst bed wherein the catalyst bed comprises a support or a supported catalyst according to any of clauses 1 to 25, optionally wherein the reactor comprises a plurality of reactor tubes comprising a support or a supported catalyst according to any of clauses 1 to 25, suitably ≥500 reactor tubes, such as ≥1000 reactor tubes.
28. A reactor tube for the production of an alkylene oxide comprising a catalyst bed wherein the catalyst bed comprises a support or supported catalyst according to any of clauses 1 to 25.
29. A reaction medium for the production of an alkylene oxide comprising a catalyst bed wherein the catalyst bed comprises a support or a supported catalyst according to any of clauses 1 to 25.
30. A method for the production of an alkylene oxide comprising the use of a reactor comprising a catalyst bed wherein the catalyst bed comprises a support or a supported catalyst according to any of clauses 1 to 25 to produce an alkylene oxide.
31. Apparatus for the production of an alkylene glycol comprising a reactor for the production of an alkylene oxide according to clauses 27 or 28 and a reactor for the production of alkylene glycol that is configured to receive the alkylene oxide produced from the alkylene oxide reactor.
32. A method for the production of an alkylene glycol comprising producing an alkylene oxide according to clause 30 and then using the produced alkylene oxide in the production of the alkylene glycol.

All of the features contained herein may be combined with any of the above aspects in any combination.

For a better understanding of the invention, and to show how embodiments of the same may be carried into effect, reference will now be made, by way of example, to the following experimental data and figures.

### Examples

Supported catalyst example 1 according to the present invention was produced from a moulding composition formed by mixing the components provided below (Table 1) using the following method.

An aqueous monomer solution containing the chain forming monomer, the chain linking monomer and the water was formed. To this dispersant was added. The pore former was then introduced and mixed until fully dispersed. The alumina powders were then mixed to form an aqueous slurry. The catalyst and initiator were then added to the aqueous slurry. The amounts of each component in the resulting slurry were:

TABLE 1
Summary of components of composition used
to prepare Supported catalyst example 1

| Component | wt % |
|---|---|
| Alumina powder 1 (X) | 34 |
| Alumina powder 2 (Y) | 1 |
| Alumina powder 3 (Z) | 21.4 |
| Pore former 1 | 8.4 |
| Pore former 2 | 0.7 |
| Dispersant | 1.1 |
| Polymer | 3 |
| Cross-linker | 1.5 |
| Catalyst | 0.7 |
| Initiator | 1.3 |
| Water | 27 |

The particle size of alumina powder 1, alumina powder 2 and alumina powder 3 are provided in Table 2 below.

TABLE 2
The D10, D50 and D90 particle size
of Alumina powder 1, 2 and 3.

| | Alumina | Alumina | Alumina |
|---|---|---|---|
| | Powder 1 (X) | Powder 2 (Y) | Powder 3 (Z) |
| D10 | 0.4-0.9 | 0.1-0.4 | 14-18 |
| D50 | 2.0-3.5 | 0.5-0.8 | 28-34 |
| D90 | 5.0-9.0 | 1.5-3.0 | 50-59 |

The resulting aqueous slurry was then cast into a mould having negative impressions operable to form surface structures on the moulded support. Once the slurry had gelled into a solid green body after 5-6 mins, it was then demoulded. At this point the green body support had a rubbery, jelly-like consistency. The green body was then dried at 110° C. for a minimum of 24 hours. The dried green body was then fired to 1450° C., at which point the binder, dispersant and pore former were burnt off to leave a solid, porous, supported catalyst-supported catalyst example 1.

Supported catalyst example 1 had a total pore volume of 0.45-0.55 cm³/g, a specific surface area of 1.8-2.1 m²/g, a mean side crush strength of 10 kgf and a pore size distribution of <1% of pores measuring 0.1 μm or below and <15% measuring 10 μm or above.

A drop test was conducted on the support/catalyst formed to determine the material brittleness, which relates to the material attrition of the support/catalyst. The drop test was completed according to the following method:

Each sample was dropped a single 12-meter vertical drop onto a flat steel plate. An operative in a cherry-picker drops each sample, one at a time, down a vertically orientated pipe. The sample contacts the steel plate at the bottom, which is viewable through a Perspex window, and it is recorded if each sample survives or breaks on contact with the steel plate. A total of 100 repeats are conducted for each sample. A trap door is used to empty the dropped samples every 5 samples. The number of surviving samples is used to calculate the percentage survival rate. A sample that has at least a 90% survival rate is considered a pass.

Supported catalyst example 1 according to the present invention passed the drop test and scored >90% survival rate.

Supported catalyst example 1 was used in a packed-bed reactor for the production of an alkylene oxide. Supported catalyst example 1 resulted in a 30% reduced pressure drop in use compared to a commercially available supported catalyst not according to the invention, as well as showing an increased activity, selectivity, attrition and catalyst lifetime.

### BRIEF DESCRIPTION OF DRAWINGS

FIG. 1 shows a perspective view of a first comparative supported catalyst.

FIG. 2 shows a perspective view of a second comparative supported catalyst

FIG. 3 shows a perspective view of a first embodiment of a supported catalyst according to the present invention.

FIG. 4 shows a perspective view of a second embodiment of a supported catalyst according to the present invention.

FIG. 5 shows the flow results for the first comparative supported catalyst with a cross-section of the side of the column along the lateral X axis.

FIG. 6 shows the flow results for the first comparative supported catalyst with a cross-section from the top of the column along the longitudinal Z axis.

FIG. 7 shows the flow results for the second comparative supported catalyst when the intra-particle flow channel is aligned with the direction of flow with a cross-section from the side of the column along the lateral X axis.

FIG. 8 shows the flow results for the second comparative supported catalyst when the intra-particle flow channel is aligned with the direction of flow with a cross-section from the side of the column along the lateral Y axis.

FIG. 9 shows the flow results for the second comparative supported catalyst when the intra-particle flow channel is aligned with the direction of flow with a cross-section from the top of the column along the longitudinal Z axis.

FIG. 10 shows the flow results for the second comparative supported catalyst when the intra-particle flow channel is at 90° to the direction of flow with a cross-section from the side of the column along the lateral X axis.

FIG. 11 shows the flow results for the second comparative supported catalyst when the intra-particle flow channel is at 90° to the direction of flow with a cross-section from the side of the column along the lateral Y axis.

FIG. 12 shows the flow results for the second comparative supported catalyst when the intra-particle flow channel is at 90° to the direction of flow with a cross-section from the top of the column along the longitudinal Z axis.

FIG. 13 shows the flow results for the second comparative supported catalyst when the intra-particle flow channel is at 45° to the direction of flow with a cross-section from the side of the column along the lateral X axis.

FIG. 14 shows the flow results for the second comparative supported catalyst when the intra-particle flow channel is at 45° to the direction of flow with a cross-section from the side of the column along the lateral Y axis.

FIG. 15 shows the flow results for the second comparative supported catalyst when the intra-particle flow channel is at 45° to the direction of flow with a cross-section from the top of the column along the longitudinal Z axis.

FIG. 16 shows the flow results for the first embodiment of a supported catalyst according to the present invention with a cross-section from the side of the column along lateral axis X.

FIG. 17 shows the flow results for the first embodiment of a supported catalyst according to the present invention with a cross-section from the top of the column along longitudinal axis Z.

FIG. 18 shows the flow results for the second embodiment of a supported catalyst according to the present invention with a cross-section from the side of the column along lateral axis X.

FIG. 19 shows the flow results for the second embodiment of a supported catalyst according to the present invention with a cross-section from the top of the column along longitudinal axis Z.

### DESCRIPTION OF EMBODIMENTS

Computational fluid dynamics (CFD) compared the performance of two comparative supported catalysts to a supported catalyst according to the present invention.

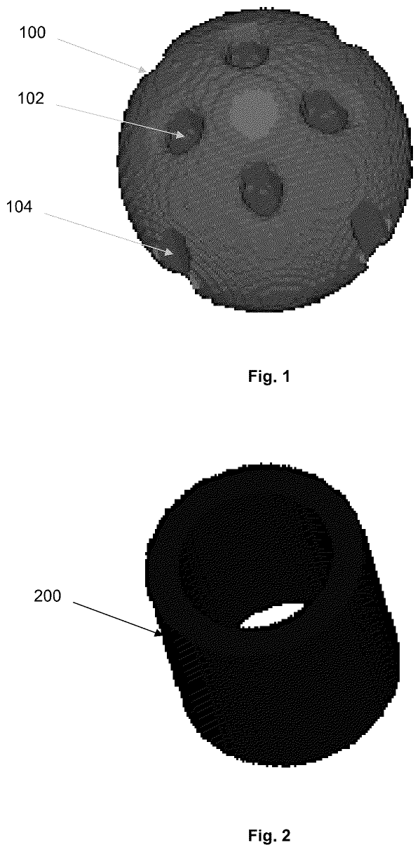

The first comparative supported catalyst 100, shown in FIG. 1, has a 16 mm diameter grooved spherical macrostructure with four equally spaced parallel fluid communication intra-particle channels in the form of bores 102 extending between apertures on opposite sides of the outer surface of the supported catalyst. The grooves 104 of supported catalyst 100 are in the form of four equally spaced parallel linear grooves with curved lateral cross-sections on the outer surface of the supported catalyst. The outer surface of the supported catalyst 100 has the expected smooth continuous curvature of a spherical macrostructure.

The second comparative supported catalyst 200, shown in FIG. 2, is known as a Rashig ring and is in the form of an 8 mm by 8 mm cylinder having a central linear intra-particle fluid channel extending from an aperture in the upper face to an aperture in the lower face. The outer surface of the supported catalyst 200 has the expected smooth continuous curvature of a cylinder macrostructure.

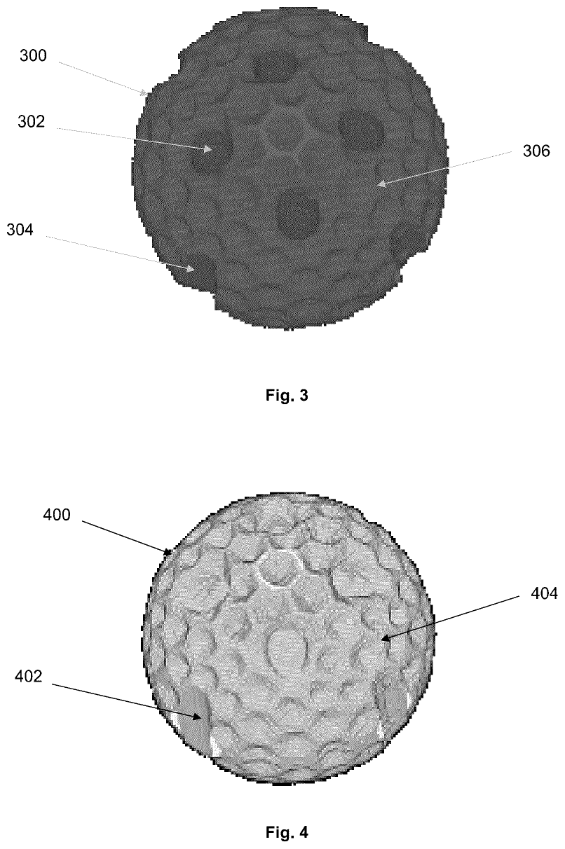

The first embodiment of a supported catalyst 300 according to the present invention, shown in FIG. 3, is the same as the first comparative supported catalyst, with bores 302 and grooves 304, but in addition the outer surface of supported catalyst 300 comprises surface structures in the form of a plurality of interconnected hexagon-shaped annular ridged surface structures 306 extending over substantially the whole of the outer surface apart from the apertures of bores 302 and the surface of grooves 304. The portion of the outer surface that extends between the inner edges of the annular ridges is formed of an open ended inverted hexagonal pyramid.

The second embodiment of a supported catalyst according to the present invention 400, shown in FIG. 4, is the same as the second comparative supported catalyst, with grooves 402 and surface structures 404, except that supported catalyst 400 does not have fluid communication intra-particle channels extending through the body of the supported catalyst.

CFD was used to test the flow around the above-mentioned supported catalysts.

The test conditions were as follows:
Large tube diameter selected so as to not interfere with flow around pellet (50 mm ID)
Simulation resolution 0.125 mm per pixel
Flow rate: 0.4 m³/min
Orientation of the holes/side-channels in the same direction of flow

The results of the flow tests were:

Measured stagnant velocity zone below pellet (truncated cone)

| | | Comp. 2 | | | | |
|---|---|---|---|---|---|---|
| | Comp. 1 | With flow | At 90° | At 45° | Ex.1 | Ex. 2 |
| Height of dead zone | 7.5 | 3.4 | 7.3 | 9.8 | 7.4 | 7.25 |
| below pellet (mm) | | | | | | |
| Volume of dead | 246.39 | 160.6 | 191.5 | 210.5 | 147.55 | 167.65 |
| zone (mm³) | | | | | | |
| Domain avg velocity | 0.05082 | 0.05015 | 0.05011 | 0.05010 | 0.05088 | 0.05095 |
| Re | 1414.8 | 1382.6 | 1382.6 | 1382.6 | 1416.5 | 1330.3 |
| Dead zone ht | 46.88 | 42.50 | 91.25 | 122.5 | 46.09 | 45.31 |
| relative to pellet | | | | | | |
| diameter, % | | | | | | |
| Dead zone vol | 13.14 | 56.39 | 67.24 | 73.91 | 8.55 | 8.79 |
| relative to pellet | | | | | | |
| vol, % | | | | | | |

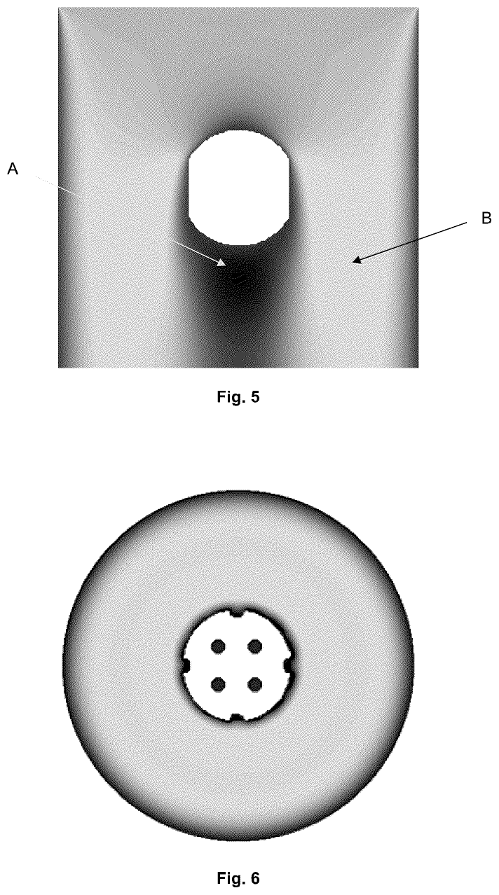

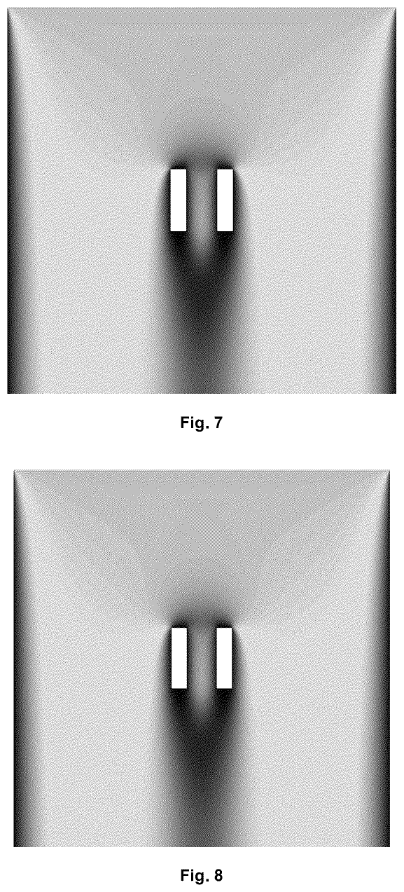

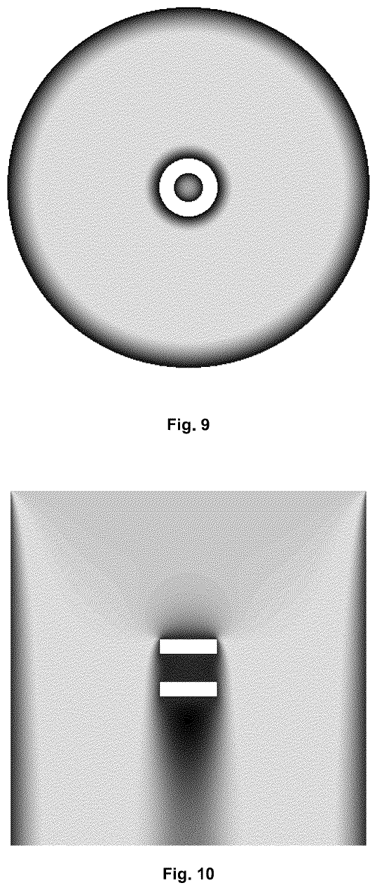

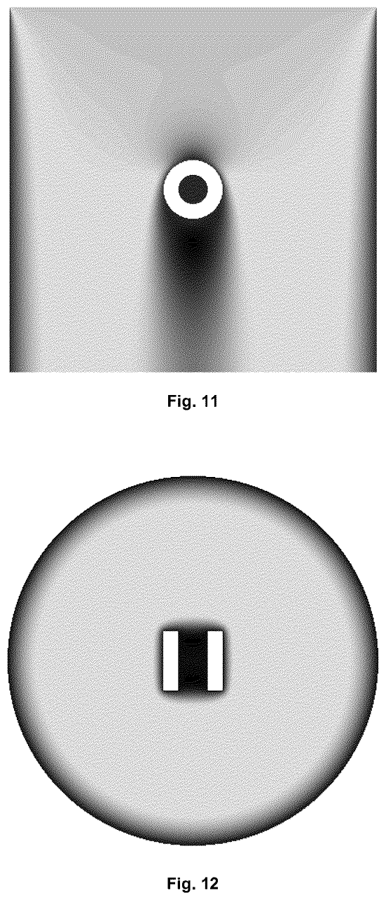

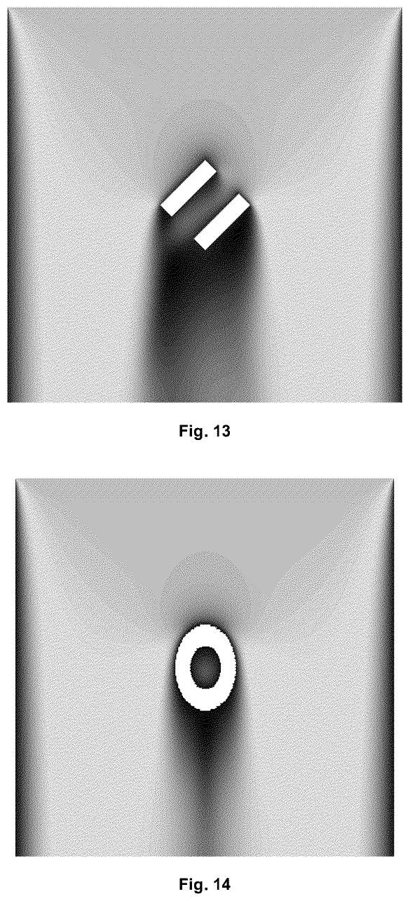

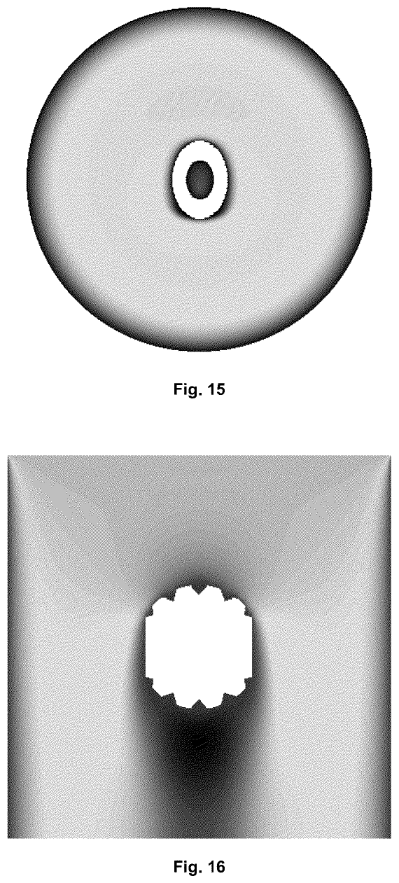

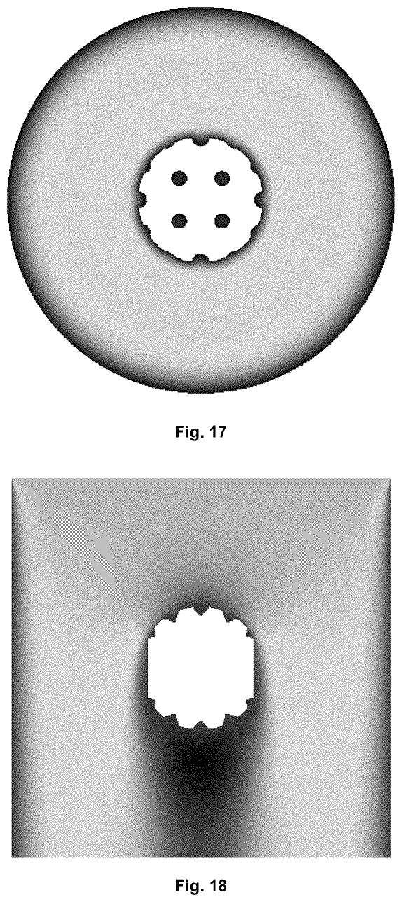

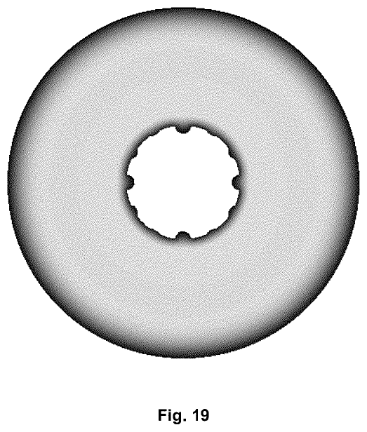

As shown by the results of the above table and in FIGS. 5 to 19, compared to the comparative supported catalysts, the supported catalysts according to the invention provides a higher gas velocity in contact with the supported catalyst. In FIGS. 5 to 19, darker areas such as “A” in FIG. 5 indicate a lower/static gas velocity and lighter areas such as “B” in FIG. 5 indicate a higher gas velocity. In addition, the supported catalysts according to the invention provides a higher amount of gas turbulence above the supported catalyst, and also provides a smaller velocity static zone below the supported catalyst.

Furthermore, for the second comparative example, it can be seen that the pellet orientation has a significant effect on the size of the dead zone (see the darkest shading below the pellet). When the pellet is orientated at 45° to the direction of flow, the dead zone volume increases from ˜50 of total pellet volume (when flow aligned) to ˜75% of pellet volume. The dead zone height is even more significantly affected, going from 43% of pellet diameter (when flow aligned) to ˜123% (45°). This would have a significant effect in a packed bed on the pellets directly below those at such an angle, reducing the catalyst-gas contact.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

The following listing of claims shall replace all prior versions and listings of claims:

1. A support for a catalyst, wherein the support comprises surface structures, wherein the support comprises ceramic material; and wherein the support has a pore size distribution wherein ≤2% of the pores have a size of ≤0.1 μm and/or has a specific surface area of at least 1.5 m²/g and/or has a total pore volume of ≥0.4 cm³/g.

2. A support for a catalyst, wherein the support comprises surface structures, and wherein the support comprises a ceramic material wherein the ceramic material comprises particle size fraction X and at least one of:
particle size fraction Y; and/or
particle size fraction Z;
and/or residues thereof;
wherein particle size fraction Y, when present, comprises ceramic particles with a D50 particle size that is ≤40% of the D50 particle size of particle size fraction X,
wherein particle size fraction Z, when present, comprises ceramic particles with a D50 particle size that is ≥300% of the D50 particle size of particle size fraction X.

3. A support for a catalyst, wherein the support comprises surface structures, and wherein the support comprises a ceramic material wherein the ceramic material comprises particle size fraction X and at least one of:
particle size fraction Y comprising ceramic particles with a D50 particle size of up to 1 μm; and/or
particle size fraction Z comprising ceramic particles with a D50 particle size of at least 15 μm;
and/or residues thereof;
wherein the D50 particle size of particle size fraction Y, when present, is smaller than the D50 particle size of particle size fraction X,
wherein the D50 particle size of particle size fraction Z, when present, is larger than the D50 particle size of particle size fraction X.

4. The support for a catalyst according to claim 1, wherein the support is a gel-cast support.

5. The support for a catalyst according to claim 1, wherein the support has a substantially spherical and/or ellipsoidal macrostructure.

6. (canceled)

7. The support for a catalyst according to claim 1, wherein the support has a pore size distribution wherein ≤25% of the pores have a size of ≥10 μm.

8.-11. (canceled)

12. The support for a catalyst according to claim 1, wherein the ceramic material comprises particle size fraction X and at least one of:
particle size fraction Y; and/or
particle size fraction Z;
and/or residues thereof,
and wherein the D50 particle size of particle size fraction Y (when present)<D50 particle size of particle size fraction X<D50 particle size of particle size fraction Z (when present).

13. The support for a catalyst according to claim 1, wherein the support is obtainable from a composition, wherein the composition comprises a ceramic material, wherein the ceramic material comprises particle size fraction X and at least one of particle size fraction Y and/or particle size fraction Z.

14. The support for a catalyst according to claim 12, wherein particle size fraction X has a D50 particle size of at least 1 μm.

15.-18. (canceled)

19. The support for a catalyst according to claim 12, wherein particle size fraction Y has a D50 particle size of at least 0.2 μm.

20.-23. (canceled)

24. The support for a catalyst according to claim 12, wherein particle size fraction Z has a D50 particle size of at least 10 μm.

25.-28. (canceled)

29. The support for a catalyst according to claim 12, wherein particle size fraction Y, when present, comprises ceramic particles with a D50 particle size that is ≤40% of the D50 particle size of particle size fraction X.

30. The support for a catalyst according to claim 12, wherein particle size fraction Z, when present, comprises ceramic particles with a D50 particle size that is ≥300% of the D50 particle size of particle size fraction X.

31. The support for a catalyst according to claim 1, wherein the support is obtainable from a composition, wherein the composition comprises a ceramic material and a pore forming material.

32. (canceled)

33. (canceled)

34. The support for a catalyst according to claim 31, wherein the pore forming material comprises a first pore forming particle size fraction and a second pore forming particle size fraction,
wherein the first pore forming particle size fraction has a D50 particle size of at least 50 μm,
and wherein the second pore forming particle size fraction has a D50 particle size of at least 150 μm.

35. (canceled)

36. (canceled)

37. The support for a catalyst according to claim 12, wherein the support is obtainable from a composition, and wherein the composition comprises at least 10 wt % of particle size fraction X based on the total weight of the composition.

38. (canceled)

39. (canceled)

40. The support for a catalyst according to claim 12, wherein the support is obtainable from a composition, and wherein the composition comprises at least 0.1 wt % of particle size fraction Y based on the total weight of the composition.

41. (canceled)

42. (canceled)

43. The support for a catalyst according to claim 12, wherein the support is obtainable from a composition, and wherein the composition comprises at least 10 wt % of particle size fraction Z based on the total weight of the composition.

44. (canceled)

45. (canceled)

46. The supported catalyst for use in a packed-bed reactor for the production of an alkylene oxide comprising a support according to claim 1.

47. (canceled)

48. The supported catalyst according to claim 46, wherein the support/supported catalyst is for use in a packed-bed reactor for the production of ethylene oxide.

49.-73. (canceled)
